(19) United States
(12) Patent Application Publication
(10) Pub. No.: US 2011/0058351 A1
(43) Pub. Date: Mar. 10, 2011

(54) CONTROL PANEL STRUCTURE OF FITNESS EQUIPMENT

(76) Inventor: Wen-Chang Yang, Taichung City (TW)

(21) Appl. No.: 12/554,974

(22) Filed: Sep. 7, 2009

(51) Int. Cl. G01D 11/28

(52) U.S. Cl. 362/26

(57) ABSTRACT

This specification discloses a control panel structure of fitness equipment that includes a control board for controlling settings and display of the fitness equipment, a panel disposed above the control board, and a plurality of light-guiding elements disposed on the panel. The light-guiding elements are parallel to the panel. Each of the light-guiding elements has a hollow part with an opening on its one end. A light-emitting source is disposed inside the light-guiding element via the opening and electrically connected with the control board.

### BACKGROUND OF THE INVENTION

1. Field of Invention

The invention relates to a control panel structure of fitness equipment and, in particular, to a panel structure that consists of several three-dimensional light-guiding elements arranged to form a specific shape.

2. Related Art

FIG. 4 shows a conventional panel 5 on a treadmill (not shown). When its user runs on the running belt, the can view from the panel his running speed, predetermined running distance, distance that he has already run, time, and the slope.

However, a normal panel displays the above-mentioned information in numbers 51. This is too boring for the runner. The runner thus cannot be stimulated to increase his thrust and enthusiasm when he is tired.

### SUMMARY OF THE INVENTION

An objective of the invention is to solve the above-mentioned problem and provide a control panel structure of fitness equipment. Using a structure of a particular shape formed by some arrangement of three-dimensional light-guiding elements on a panel, the user can experience different joys than conventional ones, as the displayed color varies with the runner's speed or slope of the running belt.

Another objective of the invention is to use the structure of a particular shape formed by some arrangement of three-dimensional light-guiding elements to distinguish from other products.

To achieve the above-mentioned objectives, the invention includes: a control board for controlling the fitness equipment and display; a panel disposed above the control board; and a plurality of light-guiding elements disposed on the panel, arranged to form a scale; wherein each of the light-guiding element has a hollow part with an opening on its one end, a light-emitting source is disposed through the opening into each of the light-guiding elements, and each of the light-emitting sources electrically connects to the control board.

### BRIEF DESCRIPTION OF THE DRAWINGS

The invention will become more fully understood from the detailed description given herein below illustration only, and thus is not limitative of the present invention, and wherein:

FIG. 1 is a planar view of the invention;

FIG. 2 is a cross-sectional view of the invention;

FIG. 3 is a cross-sectional view of another embodiment of the invention; and

FIG. 4 is a schematic view of the display panel on a conventional treadmill.

### DETAILED DESCRIPTION OF THE INVENTION

The present invention will be apparent from the following detailed description, which proceeds with reference to the accompanying drawings, wherein the same references relate to the same elements.

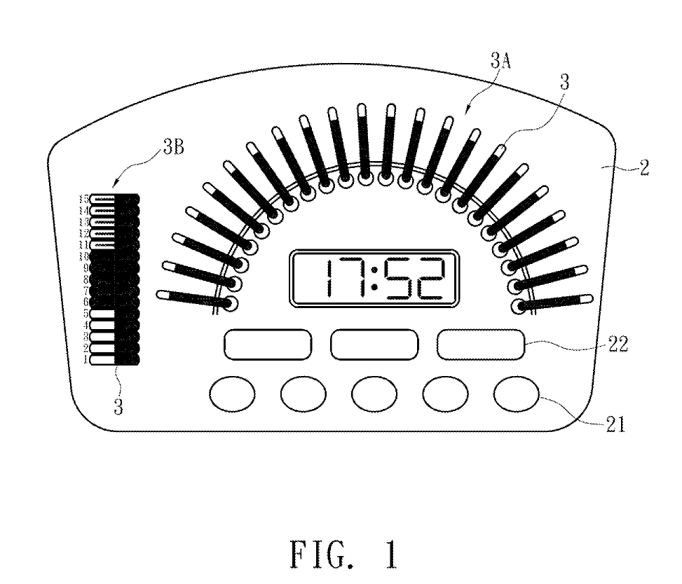

Please refer to FIGS. 1 to 3 for an embodiment of the invention. It is used solely as an example of the invention, and should not be construed to restrict the scope thereof.

The disclosed control panel structure of fitness equipment includes: a control board 1, a panel 2, and a plurality of three-dimensional light-guiding elements 3.

The control board 1 controls settings of fitness equipment (e.g., a treadmill, not shown) and displays information. The control board is further equipped with other electronic elements (not shown).

The panel 2 is disposed above the control board 1. The panel 2 has several keys 21 for settings, such as the power key, start/pause/stop key, program setting key, accelerate key, decelerate key, and safety lock key. The panel 2 also has several display units 22 for displaying sports-related values, such as distance, speed, time, calories, and heartbeat rate.

The light-guiding elements 3 are disposed above the panel 2. They are arranged above the panel 2 to form a scale. In this embodiment, some light-guiding elements 3 have a bar shape. They are in an arc shape and disposed concentrically to form semi-circular speedometer 3A. The other light-guiding elements 3 also have a bar shape and are horizontally and longitudinally arranged to form a slope meter 3B. The light-guiding elements 3 can be parallel to the panel 2, or tilted at angle to the panel 2 to form a three-dimensional structure.

A light-emitting source 41 is disposed at an end portion of each of the light-guiding elements. The light-emitting source 41 is a light-emitting diode (LED) lamp. Each of the light-emitting sources 41 electrically connects to the control panel 1 by wires. In this embodiment, each of the light-guiding elements 3 has a bar shape and a hollow part 31 with an opening 311 on one end thereof. The light-emitting source 41 is disposed inside the light-guiding element 3 via the opening 311.

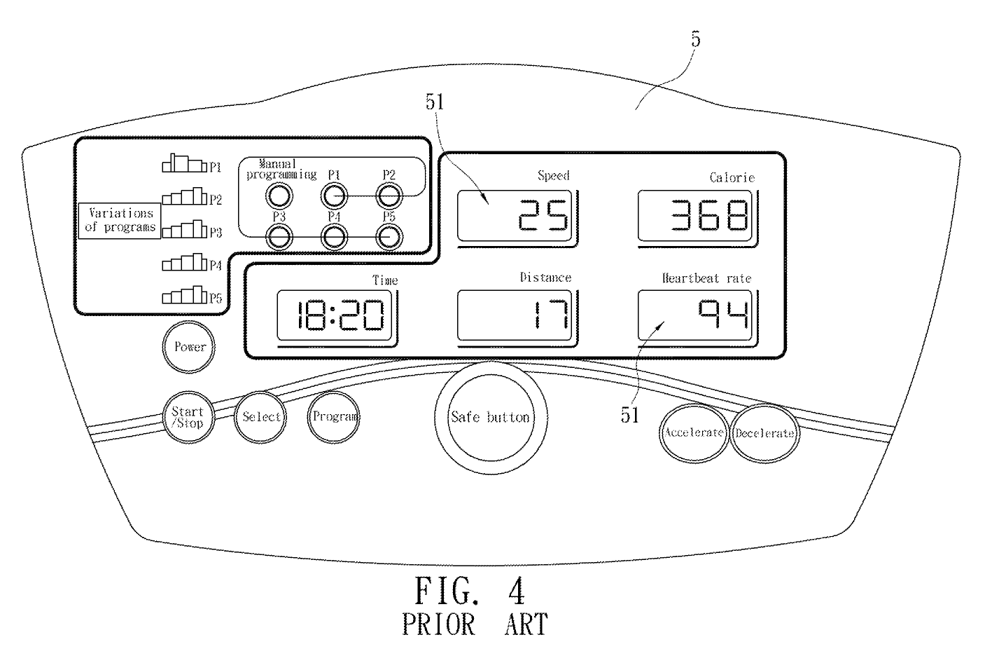

Please refer to FIG. 3. Of course, the light-guiding element 3 has other embodiments. For example, the light-guiding element has a bar shape and a solid structure 33, and the light-emitting source 42 is disposed outside the end portion of the light-guiding element 3. The light is then emitted into and through the solid light-guiding element 3.

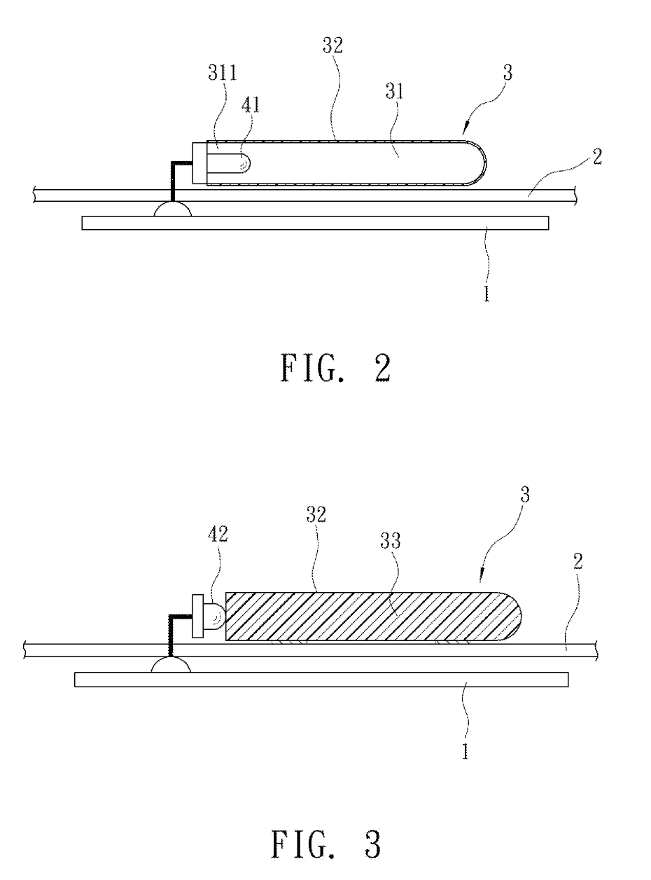

Please refer to FIGS. 2 and 3. Each of the light-guiding elements 3 is surrounded by a light-guiding film 32 for guiding light uniformly. The light-guiding film 32 is formed on the light-guiding element 3 by sand-blasting. Moreover, the light-guiding elements 3 vary their colors according to different sports values.

Please refer to FIG. 1. To use it, the user first sets the distance and time he wants to cover, slope variations, and the speed of the running belt. Of course, the user can directly select the sports mode built in the treadmill.

On the running belt, the user can directly see the special design on the panel 2. The light-guiding elements 3 form an arc-shaped and three-dimensional speedometer 3A for displaying the speed and a slope meter 3B with horizontal and longitudinal designs. As the user runs, he can experience more fun than conventional pure numerical displays.

Take the speed display as an example. As the running speed of the user changes, the light-guiding elements 3 also present different colors. The user thus can have a different feeling and fun. Of course, the slope display can be represented by different colors as well. This also increases the fun of exercises for the user.

In summary, the invention provides three-dimensional light-guiding elements and arranges them into a specific shape, rendering speed and slope displays. They vary with the exercising conditions. Each of the light-guiding elements can have different colors. Therefore, the invention provides more fun than the prior art that uses monotonic numerical displays.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A control panel structure of fitness equipment, comprising:
a control board for controlling settings and display of the fitness equipment;
a panel, which is disposed above the control board; and
a plurality of light-guiding elements disposed on the panel and arranged into a scale;
wherein a light-emitting source is disposed at an end portion of each of the light-guiding elements, and each of the light-guiding elements electrically connects to the control board.

2. The control panel structure of fitness equipment as in claim 1, wherein each of the light-guiding elements has a bar shape and a hollow part with an opening on one end thereof, and the light-emitting source is disposed inside each of the light-guiding elements via the opening.

3. The control panel structure of fitness equipment as in claim 1, wherein each of the light-guiding elements has a bar shape and is solid, and the light-emitting source is disposed outside the end portion thereof.

4. The control panel structure of fitness equipment as in claim 1, wherein the light-guiding elements have a bar shape and are disposed in an arc shape and concentrically to form a speedometer for displaying the speed.

5. The control panel structure of fitness equipment as in claim 1, wherein the light-guiding elements have a bar shape and are arranged horizontally and longitudinally to form a slope meter for displaying the slope.

6. The control panel structure of fitness equipment as in claim 1, wherein each of the light-guiding elements is surrounded by a light-guiding film for uniformly guiding light.
